(19) United States
(12) Patent Application Publication
(10) Pub. No.: US 2018/0316844 A1
(43) Pub. Date: Nov. 1, 2018

(54) SYSTEM FOR 3-D MAPPING AND MEASUREMENT OF FLUID SURFACE IN DYNAMIC MOTION

(71) Applicant: The U.S.A., Secretary of Dept of the Interior, Washington, DC (US)

(72) Inventor: Gerald A. Hatcher, JR., Scotts Valley, CA (US)

(73) Assignee: The United States of America, as represented by the Secretary of the Department of the Interior, Washington, DC (US)

(21) Appl. No.: 15/694,283

(22) Filed: Sep. 1, 2017

Related U.S. Application Data
(63) Continuation-in-part of application No. 15/582,772, filed on May 1, 2017, now abandoned.

(51) Int. Cl. H04N 5/232; H04N 5/247

(52) U.S. Cl. CPC H04N 5/23206; H04N 5/2354; H04N 5/247

(57) ABSTRACT

The invention enables multiple autonomously functioning cameras to capture highly synchronized images suitable for processing by SfM software for creating 3-D maps of waves and other features of dynamically moving ocean surfaces. The autonomously functioning cameras need not be in communication with each other through a network, thus reducing dependency on network components. The invention utilizes a microprocessor operatively coupled to the operating system of a camera to synchronize the shutter release component of cameras to an external signal. Large numbers of cameras can be synchronized to an external signal, such as a 1 PPS GPS signal, and can be calibrated in real time to reduce synchronization error to less than 1/1000 per second.

This application is a continuation-in-part and claims the benefit of U.S. patent application Ser. No. 15/582,772 filed May 1, 2017.

### STATEMENT REGARDING FEDERALLY SPONSORED RESEARCH OR DEVELOPMENT

The invention described herein was made by employees of the United States Government and may be manufactured and used by the Government of the United States of America for governmental purposes without payment of royalties.

### FIELD OF INVENTION

This invention relates to the field of image analysis and more specifically to a system for mapping three-dimensional (3-D) surfaces using two-dimensional (2-D) images.

### BACKGROUND OF THE INVENTION

The U.S. Geological Survey (USGS) is the scientific bureau of the Department of Interior, and has an evolving mission to collect remote data related to the earth's land and water. The USGS has a mandate to advance scientific study of oceanic and coastal areas and improve predictive capabilities relative to catastrophic events and oceanic conditions; nearly 40% of the U.S. population lives in coastal areas.

USGS scientists require 3-D elevation surveys (maps) to create predictive models of wave conditions and heights, directions, periodicity, water fluxes, pressure fields and momentum or waves at various points in time.

Advancements in imaging technologies have enabled scientists to create 3-D elevation surveys using 2-D images taken from cameras moving drones, planes or at strategically placed locations. The 2-D images are graphically processed using an imaging technology known in the art as “Structure from Motion” or “SfM”.

The SfM algorithm produces 3-D maps by processing a sequential set of images from drones as the drone travel relative to the area or object of interest. SfM uses points of overlap in the images to produce the 3-D map.

It is a problem known in the art that SfM cannot effectively process images of moving water surface features, such as waves. The SfM algorithms cannot reconcile the movement of water surface with the movement of the vehicle on which the camera is mounted. Currently, scientists mask moving features out of photographs used for an SfM dataset.

To address the limitations of the SfM algorithms, scientists rely on networks of fixed-position cameras to photograph dynamically moving water surface features. The fixed-position cameras capture overlapping images from multiple vantage points at a synchronized point in time. Typically, the cameras receive a network signal to control the timing of the shutter release so the capture of images at the same time.

There are several problems known in the art with respect to obtaining images image sets suitable for SfM processing. It is necessary that all images be accurately synchronized within an acceptable range of error. Synchronization errors of even a few thousandths of a second can interfere with the 3-D mapping process and the sensitive SfM algorithm for rapidly moving water surface features.

The network equipment used to produce image sets for SfM processing also introduces error. Network signal delays and mechanical differences in individual cameras result in synchronization errors.

There is an unmet need for camera equipment and image capture systems which can produce highly synchronized 2-D image sets of waves and dynamically moving water surfaces suitable for 3-D mapping.

### BRIEF SUMMARY OF THE INVENTION

The invention is an Autonomous Camera Synchronization Apparatus (ACS) for synchronizing image capture to a signal that is external to a camera. The ACS includes a receiver external signal, such as a one pulse per second (PPS) signal. The receiver is mounted or otherwise positioned in communication with camera that has a remote shutter release component.

The ACS further includes a microprocessor that is operatively coupled with the receiver and plurality of signal bus components. Each of the signal bus components operatively couples said microprocessor to the operating system of a camera to control the shutter release component of the camera.

The microprocessor further includes a virtual processing component configured to compute a time delay value that is the difference between the time an external signal is received by the receiver and a second time value which is the time that the shutter release component of the camera is activated.

The microprocessor also includes a second virtual processing component which applies said time delay to synchronize the time at which said microprocessor sends a shutter release signal to operating system of camera, to synchronize activation of the shutter release component of the camera to the shutter release activation of other cameras configured to receive said external signal.

The time delay is a quasi-unique value that is unique to a particular camera and which corresponds to the difference between the time an external signal is received by the receiver and the time said shutter release component of the camera is activated.

### BRIEF DESCRIPTION OF THE DRAWINGS

FIG. 1 illustrates an exemplary Autonomous Camera Synchronization (“ACS”) apparatus coupled with an autonomously functioning camera.

FIG. 2 illustrates processing components contained within an ACS control unit.

FIG. 3 illustrates a system of ACS devices utilized to obtain 2-D image sets from a plurality of autonomously functioning cameras for requirements for 3-D mapping.

FIG. 4 illustrates the one-to-one relationship between the inherent functionality of ACS components and the resulting method of image synchronization for 3-D mapping.

### TERMS OF ART

As used herein, the term “area of image overlap” means a common area captured by two or more images.

As used herein, the term “autonomously-functioning” means a device which performs without regard to the signal, operation or behavior of other devices performing the same function and/or which is not dependent on receiving a signal on a network.

As used herein, the term “configured” means having any all structural adaptations known in the art to accomplish a purpose or function identified.

As used herein, the term “image set” means a set of 2-D images produced from a synchronized or contemporaneous image capture events camera which have a sufficiently low synchronized error so that the images may be processed using SfM technology.

As used herein, the term “minimum required spatial resolution” means the capability of a sensor to observe or measure the smallest object clearly with distinct boundaries.

As used herein, the term “offset value” or “time delay” means a value calculated to produce a timing delay.

As used herein, the term “operatively coupled” means a relationship between two or more elements wherein each named element performs any and all functions which the designated element is known in the art to be capable of performing to accomplish the result desired by coupling the components.

As used herein, the term “processor” means computer hardware which includes circuitry structurally placed to performing calculations, functions and operations which may be limited, determined or designated by software.

As used herein, “quasi-unique” means a value or attribute that is unique to an identifiable set of values and attributes, or which may vary based on characteristics of each item or element within the set.

As used herein, the term “receiver” means any structure added to a camera to receive a signal independently of the camera's operating system.

As used herein, the term “server” means one or more computer processing components capable of performing one or more processing tasks; a server may include components which are geographically distributed and may include one or more network components.

As used herein, the term “range of vision” means parameters of an image based on settings and attributes of a camera.

As used herein, the term “real time” means a duration sufficient to achieve synchronization within an acceptable degree of error.

As used herein, the term “signal bus” means any physical or virtual component use to convey a signal.

As used herein, the term “external signal” means any detectible or measurable electronic impulse regardless of the means of transmission and/or detection, including but not limited to a signal transmitted by a satellite or other device or a signal activated by a user.

As used herein, the term “speed of the subject” means the speed of the fastest moving object in an area captured by an image.

As used herein, the term “structure from motion” or (SfM) means any technology used to produce 3-D images from images that are not 3-D.

As used herein, the term “synchronization error” means the difference in time between two events referred to as “synchronized.”

As used herein, the term “virtual processing component” or “object” refers to software which performs a computational process and functions identically to the circuitry of a physical processor.

### DETAILED DESCRIPTION OF THE INVENTION

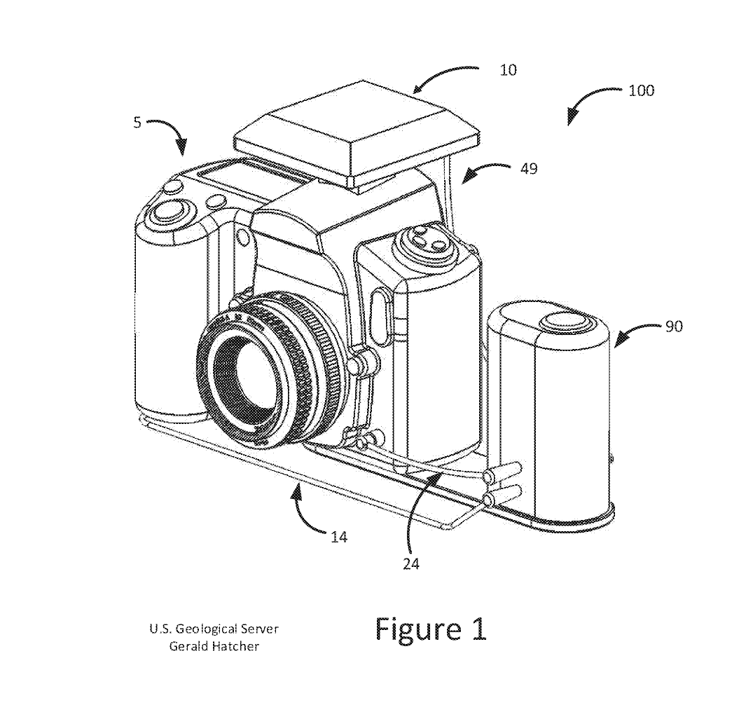

FIG. 1 illustrates an exemplary Autonomous Camera Synchronization (“ACS”) apparatus 100 in use with camera 5. Camera 5 is an autonomously functioning device for capturing images. An autonomously functioning image capture device operates independently without network communication and without regard to the functionality of other cameras or image capture devices.

Camera 5 is a camera known in the art which is configured so that its shutter release component can be remotely activated for image capture.

In the embodiment shown, ACS apparatus 100 is comprised of receiver 10, control unit 90 and signal bus components 14, 22 and 24. In the embodiment shown, signal bus components 14, 22 and 24 are wires or circuits for transmitting particular types of signals between the operating system of camera 5 and control unit 90 of ACS apparatus 100. In other embodiments, signal bus functions may be accomplished with wireless or virtual components.

In the embodiment shown, receiver 10 is an antenna, but may be any physical, mechanical structural or virtual component known in the art for receiving an externally generated signal to which multiple autonomously functioning cameras may be synchronized. In the exemplary embodiment shown, receiver 10 captures a signal from an external GPS satellite which has a standard rate of one pulse per second (PPS). In various embodiments, receiver 10 may be an external, internal, wireless device, light sensor or any other type of component known in the art for receiving an external signal. In the embodiment shown, receiver 10 is operatively coupled with a GPS module which is commercially available and known in the art. The GPS module (not shown) enables ACS apparatus 100 to receive 1 PPS external signal from a GPS satellite. In other embodiments, external signal may be a broadcast signal, an irregular signal, environmental phenomena or a signal that is generated by a user or computer.

In the exemplary embodiment shown, signal bus components 14, 22 and 24 convey signals to and from the operating system and components of camera 5 that are utilized in an inherent process to control timing of the shutter release and image capture functions of camera 5.

In the embodiment shown, receiver 10 is an antenna. In the embodiment shown, external signal bus 14 conveys the external signal captured by receiver 10 to a microprocessor contained within ACS control unit 90. The microprocessor records the time at which it receives the external signal conveyed by external signal bus 14. The microprocessor then applies a calculated offset value to produce a time delay for transmitting a shutter release signal. The delay synchronizes the timing of image capture by camera 5 with other autonomously functioning cameras. The microprocessor conveys the shutter release signal through shutter release signal bus 22 to control the timing of the shutter release component of camera 5.

After an image is captured, image verification signal bus 24, conveys a signal, in real time, which verifies the time of the shutter release.

The microprocessor then computes differential between the external signal and the image capture event and stores the resulting calculation as an offset value which is used by the microprocessor to produce a time delay.

In various embodiments, verification signal bus 24 may sense that an image has been captured by detecting a change in light or voltage that occurs in real time with an image capture event. Verification signal bus 24 then conveys the signal to the control unit 90 to calculate the delay between the signal received from external signal bus 14 and verification signal bus 24. In the exemplary embodiment shown, the voltage across the flash port of a camera is used to verify an image capture event.

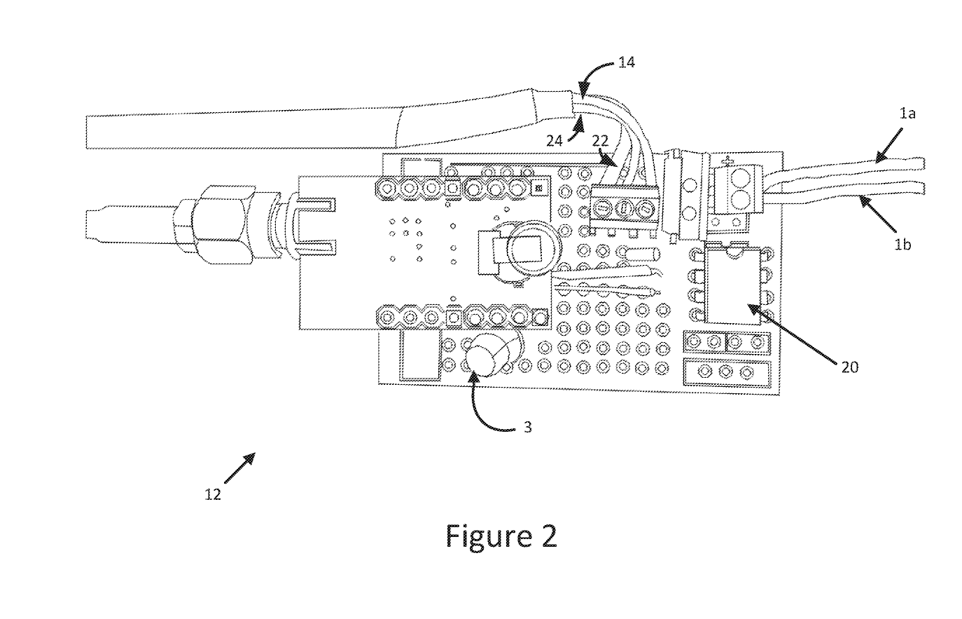

FIG. 2 illustrates processing components contained within an ACS control unit 90. These components include receiver 10, power source 1a and 1b, signal processing module 12, external signal bus 14, microprocessor 20, shutter release signal bus 22 and verification signal bus 24.

In the exemplary embodiment shown, signal processing module 12 includes a GPS module that produces 1 PPS standard GPS signal. Receiver 10 is an antenna to improve signal-receiving capability. Receiver 10 may be positioned externally on the camera housing, or may be placed internally.

External signal bus 14 is a cable, circuit, signal or other means for transmitting the external synchronization signal to microprocessor 20. The internal clock component of microprocessor 20 records the time at which an external signal is transmitted by external signal bus 14. The time that external signal is received is recorded by the internal clock and stored in the memory of microprocessor 20.

Upon receipt of an external signal, microprocessor 20 conveys a signal through shutter release signal bus 22. In various embodiments shutter release signal bus 22 may be a wire, cable, circuit, sensor or a transmitted signal or any means known in the art for transmitting a signal.

In the embodiment shown, image verification signal bus 24 receives a signal from the flash or other mechanism of the camera to indicate the actual time of image capture, and transmits the signal to microprocessor 20. The time that verification signal is received is recorded by the internal clock and stored in the memory of microprocessor 20.

Microprocessor 20 includes circuitry and/or virtual components to perform a function to calculate the difference between the time the external signal is received by shutter release signal t bus 22 and the time that the image verification signal is received by verification signal bus 24. The resulting offset value is stored in microprocessor 20. The offset value is used to determine a delay between the time after which microprocessor 20 receives an external signal and sends a signal to shutter release signal transmission component 22 when capturing successive images.

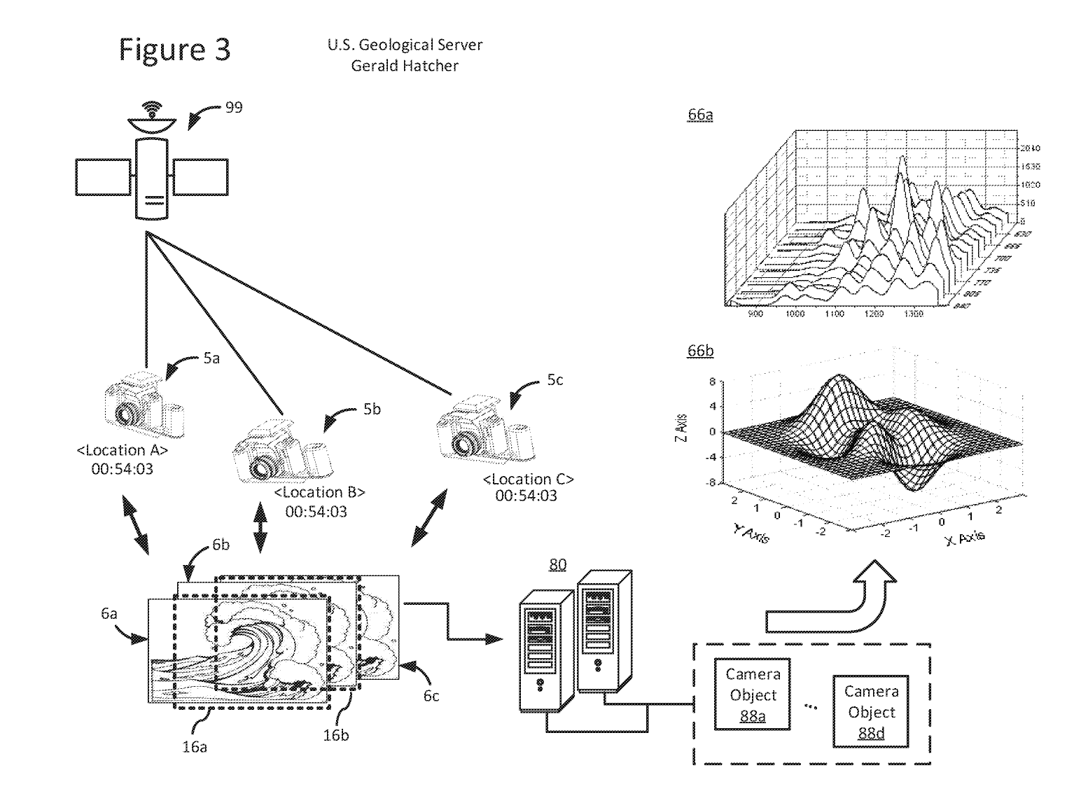

FIG. 3 illustrates an exemplary image capture system 300 in which multiple ACS 100 apparatuses are separately and operatively coupled to autonomously functioning cameras 5a, 5b and 5c. Cameras 5a, 5b and 5c are located in various positions and different angles and vantage points.

Image capture system 300 results synchronizes images 6a, 6b, and 6c which depict waves and dynamically moving water surfaces feature at a discrete point in time. Image capture is synchronized to an external signal produced by transmitter 99, which in the embodiment shown is a satellite.

Use of ACS 100 apparatuses on cameras 5a, 5b and 5c reduces synchronization error. Synchronization error is reduced below a critical level necessary to allow the 2-D image images 6a. 6b, and 6c to be mapped to 3-D images 66a and 66b. [057] ACS 100 apparatus controls synchronization errors attributable to mechanical and environment differentials of each of the autonomously functioning cameras 5a, 5b, and 5c. ACS 100 apparatus adjusts for minute timing differences in the responsiveness of each camera attributable to factors including, but not limited to, mechanical variations and variations in conditions or external environments (e.g., pressure, wind, moisture) in which each autonomously functioning camera is placed.

ACS 100 apparatus may be used on any number of camera 5 devices and on heterogeneous type of devices. In various embodiments, synchronization error may be reduced to levels closer to zero as the microprocessor 20 capability is improved.

In the exemplary embodiment, a plurality of ACS 100 apparatuses are coupled to cameras of heterogeneous types that are placed in different positions to produce a synchronized image set of water surface features at a discrete moment in time, while retaining the ability of each camera to function autonomously.

The autonomous functionality of each camera enables image capture and research areas in which cameras cannot be adequately cabled and hard-wired together. Image capture system 300 is not constrained to fixed locations which is a limitation in of the previous methods. Accordingly, image capture system 300 may be used for a much wider range of in situ studies than networked camera systems known in the art. Image capture system 300 simplifies in situ studies of water surface features in remote locations such as rivers, estuaries, irrigation channels, industrial sites, and mobile laboratories, upon determining correct placement of the cameras.

ACS apparatus 100 interacts with the image processing components of each camera to compensate for timing differences caused by mechanical specifications and the condition of each individual camera to synchronize image capture to an external signal

In other embodiments, ACS apparatus 100 may provide synchronized image outputs based on user-defined processing parameters.

In the embodiment shown in FIG. 3, autonomously functioning cameras 5a, 5b and 5c are operatively coupled to ACS 100 apparatuses. ACS apparatus may or may not be in communication with server 80 which is configured with hardware processing components and virtual processing components, and may include SfM software as well as project and field study planning tools. In one exemplary embodiment, server 80 creates a computer-generated model of the fixed positions in which autonomously functioning cameras 5a, 5b and 5c should be placed to account for the range of vision of each camera, in order to produce critical overlapping areas 16a an 16b necessary for SfM processing.

In various embodiments, server 80, may instantiate project object 81 to track image sets and to model and the positon of a plurality of cameras 5a, 5b and 5c to continuously improve the resulting image data sets. Exemplary project object 81 is a virtual processing component with data attributes and functions related to a study dynamically moving water surfaces physical surface or other area under study. An exemplary project object 81 may include scientifically identified attributes and parameters such as maximum speed of any entity moving within the parameters and required spatial resolution and speed of the subject (e.g. wave speed), which improve the suitability of the 2-D image data sets for 3-D mapping.

In other exemplary embodiments, server 80 may further include camera objects 88a, 88b and 88c which are virtual processing components for tracking camera assets in the field. In various embodiments, camera objects 88a, 88b and 88c may be used for modeling the range of vision of each camera to produce an image set with the critical overlapping areas 16a and 16b. In various embodiments, camera objects 88a, 88b and 88c may include and update position attributes and values including but not limited to camera angle attributes, shutter speed attributes, resolution attributes, lens parameter attributes, and pixels per inch attributes, as well as any other attribute relevant to producing 2-D image sets for 3-D mapping. Camera objects 88a, 88b and 88c may include independent processing functions to which are used to calculate and/or model range of vision and an expected 2-D image set.

In various embodiments, server 80 performs functions using the position attributes, angle attributes, shutter speed attributes, and lens parameter attributes of camera objects 88a, 88b and 88c to calculate the area of image overlap 16a and 16b necessary for SfM processing.

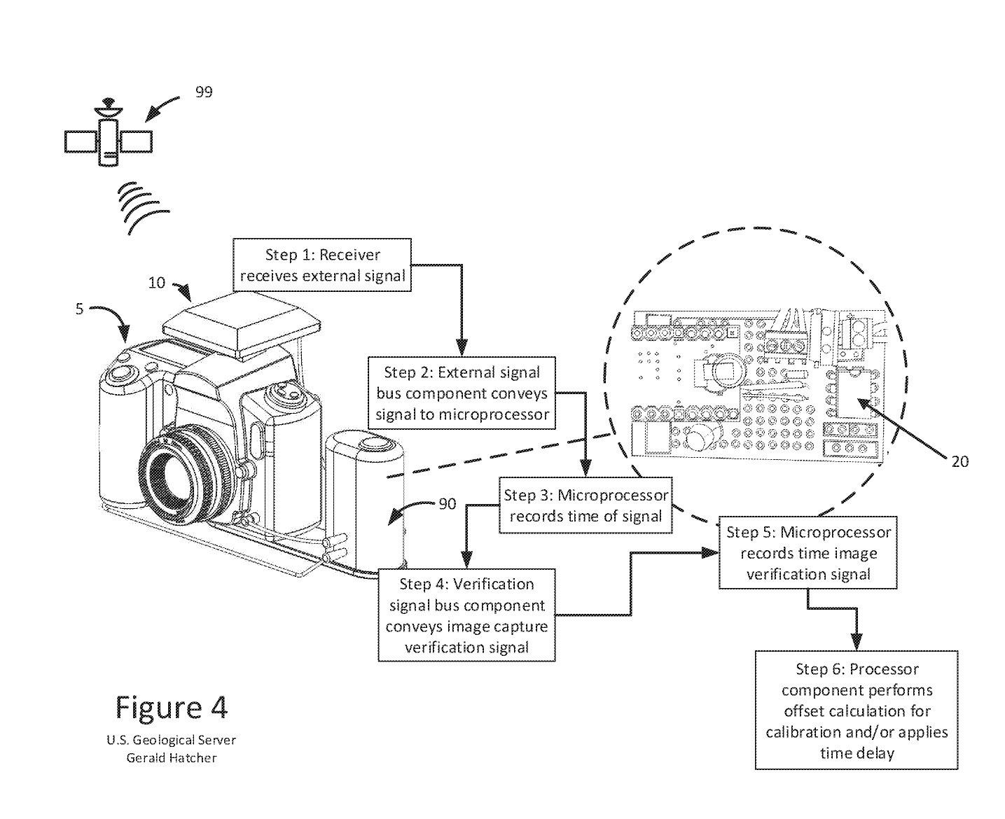

FIG. 4 illustrates the one-to-one relationship between the functionality of components of ACS 100 apparatus and the method of mapping 3-D surfaces using 2-D images. ACS 100 apparatus is designed inherently to perform a single image capture function to critically reduce synchronization error.

Step 1 is the step of receiving an external signal.

Step 2 is the step of the external signal bus conveying the external signal to a microprocessor contained within the control unit.

Step 3 is the step of recording the time that the external signal is received.

Step 4 is the step of conveying a signal from microprocessor to the shutter actuation component of the camera using the shutter release signal bus component.

Step 5 is the step of the microprocessor receiving an image verification signal conveyed by an image verification signal bus and recording the time of the verification signal.

Step 6 is the step of calculating or updating a previously calculated time delay based on the response time of the camera achieve synchronization with other autonomously functioning cameras receiving the same external signal. The time delay is a quasi-unique value that is determined by the specific mechanical and environmental attributes associated with a particular camera.

What is claimed is:

1. A camera synchronization apparatus for synchronizing image capture to a signal that is external to a camera, comprised of:
a receiver for receiving an external signal, wherein said receiver is in communication with a camera having a remote shutter release component;
a microprocessor operatively coupled with said receiver; and
a plurality of signal bus components, wherein each of said signal bus components operatively couples said microprocessor to the operating system of said camera to control the shutter release component of said camera;
wherein said microprocessor includes:
a first virtual processing component configured to compute a time delay value that is the difference between a first time which is the time an external signal is received by said receiver and a second time which is the time said shutter release component is activated; and
a second virtual processing component which applies said time delay to synchronize the time at which said microprocessor sends a shutter release signal to said operating system of said camera, to synchronize activation of said shutter release component of said camera to the shutter release activation of other cameras configured to receive said external signal.

2. The apparatus of claim 1 wherein said time delay is a quasi-unique value that corresponds to the difference between the time an external signal is received by said receiver and the time said shutter release component is activated for said camera, wherein time delay is calculated for a specific camera at a specific point in time.

3. The apparatus of claim 1 wherein said plurality of signal bus components includes an external signal bus component wherein said external signal bus component is configured to convey said external signal from said receiver to said microprocessor.

4. The apparatus of claim 1 wherein said plurality of signal bus components includes a shutter release signal bus component configured to convey a shutter release signal from said microprocessor to a shutter activation component of a camera.

5. The apparatus of claim 1 wherein said plurality of signal bus components includes a verification signal bus component configured to convey a verification signal to said microprocessor to verify that an image has been taken.

6. The apparatus of claim 1 wherein said plurality of signal bus components may be combined into a single structure which performs the function of two or more signal bus components.

7. The apparatus of claim 1 wherein said camera is an autonomously functioning camera that is not in communication with other cameras on a network.

8. The apparatus of claim 1 wherein said receiver is configured to receive an external signal selected from a group consisting of a signal generated by a satellite, a signal generated by a computer, a sensed input, a computer-generated input, a mechanically generated input and a user input.

9. The apparatus of claim 1 which further includes a GPS satellite communication module operatively coupled with said microprocessor for receiving a satellite transmission.

10. The apparatus of claim 1 wherein said external signal is a 1 Pulse Per Second signal.

11. The apparatus of claim 1 wherein each of said signal bus components is selected from a group consisting of a cable, a wire, a circuit and an electrical signal.

12. The apparatus of clam 1 wherein said microprocessor includes physical memory allocated to store said first time value representing the time said external signal is received by said microprocessor and physical memory allocated to store said second time value to reflect the time that said microprocessor receives said image verification signal.

13. The apparatus of claim 12 wherein said microprocessor is configured to perform a calibration function by updating said first time value and said second time value.

14. The apparatus of claim 1 wherein said verification signal bus component is configured to convey a signal produced by a flash of light selected from a group consisting of light from a camera flash mechanism and light generated from a remote source.

15. The apparatus of claim 1 wherein said verification signal bus component conveys a signal that is the change in voltage across an external port of a camera.

16. The apparatus of claim 1 wherein said verification signal bus component is physically coupled with a flash component interface of said camera.

17. A system for synchronizing the image capture by two or more autonomously functioning cameras comprised of:
a plurality of autonomously functioning cameras; and
a plurality of synchronization apparatuses, each of which is operatively coupled to one of said plurality of autonomously functioning cameras;
wherein each of said synchronization apparatuses is comprised of:
a microprocessor component in communication with said autonomously functioning camera;
an external signal bus component configured to convey said external signal from said receiver to said microprocessor;
a shutter release signal bus component configured to convey a shutter release signal from said microprocessor to a shutter activation component of a camera;
a verification signal bus component configured to convey a verification signal to said microprocessor to verify that an image has been taken;
a processing component configured to compute the time difference between receipt of said external signal by said microprocessor and receipt of said verification signal and to store said time difference as offset value; and
a processing component to apply said offset value to delay transmission of said shutter release signal from said microprocessor.

18. The system of claim 17 which further includes a server which is configured with virtual processing components selected from a group consisting of project objects, camera objects and SfM processing components.

19. The system of claim 17 wherein one or more of said autonomously functioning cameras have heterogeneous mechanical specifications.

20. A method of synchronizing image capture to a signal that is external to a camera, comprised of the steps of:
receiving an external signal;
transmitting said external signal to a microprocessor operatively coupled with a camera having a remote shutter release component;
computing a time delay value that is the difference between a first time which is the time an external signal is received by said receiver and a second time which is the time said shutter release component is activated; and
synchronizing the time at which said microprocessor sends a shutter release signal to said operating system of said camera based on said time delay value.
